(19) United States
(12) Patent Application Publication
(10) Pub. No.: US 2005/0103690 A1
(43) Pub. Date: May 19, 2005

(54) Micro liquid control system

(75) Inventors: Takashi Kawano, Anjo-shi (JP); Naritoshi Kanai, Tokyo (JP); Masanori Yamamoto, Kariya-shi (JP)

Correspondence Address: REED SMITH LLP, Suite 1400, 3110 Fairview Park Drive, Falls Church, VA, 22042, US

(73) Assignee: Aisin Seiki Kabushiki Kaisha

(21) Appl. No.: 10/990,460

(22) Filed: Nov. 18, 2004

(30) Foreign Application Priority Data
Nov. 19, 2003 (JP) 2003-389447

(51) Int. Cl. B03C 7/00

(52) U.S. Cl. 209/576; 209/128

(57) ABSTRACT

The present invention provides a micro liquid control system which, adopting a method to flow a fine target object such as droplets together with a main liquid, allows high speed, large quantity processing for sorting the target object such as the droplets. The system comprises a microchannel, which includes a main channel to flow the main liquid in which the fine target object is dispersed and a sorting channel to sort the target object at the downstream side of the main channel, and a target object selecting means, which selects the target object flowing in the microchannel and supply it to the sorting channel. The target object selecting means comprises electrodes on which the voltage of the same polarity or the opposite polarity is applied to move and select the target object with the attractive or repulsive force.

### CROSS REFERENCE TO RELATED APPLICATION

This application is based on and claims priority under 35 U.S.C. §119 to Japanese Patent Application 2003-389447, filed on Nov. 19, 2003, the entire content of which is incorporated herein by reference.

### BACKGROUND OF THE INVENTION

1 Field of the Invention

This invention relates to a micro liquid control system which selects a target object such as a droplet etc.

2. Description of the Related Art

Japanese Patent Application Laid-Open No. H10(1998)-267801 (hereinafter referred to the Patent document 1) discloses a handling apparatus of fine liquid particles wherein a plurality of electrodes are arranged to form an electrode array on a substrate; droplets of agents and specimen are formed; the droplets are put on the hydrophobic surface; transporting of the droplets is preformed by electrostatic force with the voltage application in sequence to the electrode array. The surround of the droplet is not liquid phase but gas phase. According to this invention, the droplet is transported with the electrostatic force by applying the voltage to the electrode array in sequence, and hence a pump to transport the droplet is not necessary.

Japanese Patent Application Laid-Open No. 2002-163022 (hereinafter referred to the Patent document 2) discloses a flow control technology in a micro system wherein a material which is converted between sol-gel by an external stimulation is added to a liquid which flows through a fine flow channel in the micro system; by applying the stimulation to appropriate part of the fine flow channel, the liquid is converted to gel to form a bank; the bank is converted back to the liquid when the stimulation is removed so that the flow of the liquid is controlled. According to this invention, a closing valve is formed by utilizing the phase change from sol to gel and an opening valve is formed by utilizing the phase change from gel to sol.

Japanese Patent Application Laid-Open No. 2002-528699 (hereinafter referred to the Patent document 3) discloses a micro cell sorter wherein a cell is placed in an electrolyte solution containing ions; an electric current is applied to an electrode inserted in the electrolyte solution to select the cell.

According to the above-described invention of the patent document 1, droplets are transported with an array of electrodes, but it does not select the droplets according to species of the droplets. Also it does not transport the droplets as a liquid flow, but, since the droplets are transported with electrostatic force, a transportation speed is slow and it is not suitable for a high speed, large quantity processing. Furthermore, since the surround of the droplet is not liquid phase but gas phase, the droplet is easily evaporated.

According to the above-described technology according to the patent document 2, it is the method wherein a micro specimen flows along with the flow of a liquid. But, since it utilizes chemical phase changes from sol to gel and from gel to sol, the response time is slow and it is not suitable for high speed, large quantity processing. And, as it forms a closing valve using the phase change from sol to gel and an opening valve using the phase change from gel to sol, the flow stagnates around the valves and is easily choked so that the controllability of the liquid is not good enough.

According to the above-described technology according to patent document 3, the cell is selected, but any of a charging method, electromagnetic force or dielectric constant of a specimen is not used. Also, because an electric current is applied to an electrode inserted in an electrolyte solution, the temperature of the electrolyte solution may rise depending on conditions and it is not preferable for sustaining the life of the cell which is contained in the electrolyte solution.

### SUMMARY OF THE INVENTION

The present invention is made by taking the above-described situation into consideration. The objective of the present invention is to propose a micro liquid control system which has an advantage of high speed and large quantity processing and also it can select the target object such as droplets in units.

(1) According to a first aspect of the present invention, a micro liquid control system comprising: a microchannel including a main channel to flow a main liquid in which fine target objects are dispersed and a sorting channel which, situated at the downstream side of the main channel, sorts the target objects; and a target object selecting means which selects the target objects flowing in the microchannel and supplies them to the sorting channel, wherein the target object selecting means is provided with an electrode which moves the target objects with the attractive or repulsive force by applying a voltage with the opposite or the same polarity as that of the target objects and selects the target objects. In general, preferably the target object may be electrically conductive and the main liquid may have an electrically insulating property.

(2) According to a second aspect of the present invention, a micro liquid control system comprising: a microchannel including a main channel to flow a main liquid in which fine target objects are dispersed and a sorting channel which, situated at the downstream side of the main channel, sorts the target objects; and a target object selecting means which selects the target objects flowing in the microchannel and supplies them to the sorting channel, wherein the target object selecting means is provided with a magnetic field generating part which moves the target objects flowing in the main channel of the microchannel with an electromagnetic force and selects the target objects.

(3) According to a third aspect of the present invention, a micro liquid control system comprising: a microchannel including a main channel to flow a main liquid in which fine target objects are dispersed and a sorting channel which, situated at the downstream side of the main channel, sorts the target objects; and a target object selecting means which selects the target objects flowing in the microchannel and supplies them to the sorting channel, wherein the target object selecting means is provided with an electrode which attracts, with the application of a voltage, the target object flowing in the main channel of the microchannel when the dielectric constant of the target objects is larger than that of the main liquid.

### BRIEF DESCRIPTION OF THE DRAWINGS

FIG. 1 shows schematically the configuration of a micro liquid control system of the first embodiment.

FIG. 2 shows schematically the configuration of the main part of the micro liquid control system of the first embodiment.

FIG. 3 is the sectional view around an electrical charging part of the first embodiment and is the view taken along the line III-III of FIG. 2.

FIG. 4 is the sectional view around a sorter part of the electrical charging part of the first embodiment and is the view taken along the line VI-VI of FIG. 2.

FIG. 5 shows schematically the configuration of a main part of a micro liquid control system of the second embodiment.

FIG. 6 is the sectional view around an electrical charging part of the second embodiment.

FIG. 7 shows schematically the configuration of a main part of a micro liquid control system of the third embodiment.

FIG. 8 is the sectional view around a sorter part of the third embodiment.

FIG. 9 is the explanatory figure showing the process of forming a droplet by a droplet forming means.

FIG. 10 is the explanatory figure showing the process of forming the droplet by the droplet forming means.

FIG. 11 is the explanatory figure showing the process of forming the droplet by the droplet forming means.

FIG. 12 is the view taken along the line A-A of FIG. 9.

FIG. 13 is the perspective view of a droplet counting part.

FIG. 14 is the perspective view of a droplet counting part related to the other example.

FIG. 15 shows schematically the configuration of a main part of a micro liquid control system of the fourth embodiment.

FIG. 16 is the sectional view taken along the line D-D of FIG. 15.

FIG. 17 shows the configuration around a sorter channel related to the other embodiment.

### DESCRIPTION OF THE PREFERRED EMBODIMENTS

According to the preferred embodiment of the present invention, a configuration may be adopted where a target object forming means which forms the target object is provided at the upstream side of the target object selecting means. Especially, a configuration may be adopted where a target object of droplet form is formed by the target object forming means provided at the upstream side of the selecting means. In this case, a configuration may be disclosed where the target object is electrically charged after the formation of a droplet target object. Or, a configuration may be disclosed where the target object is electrically charged during the formation of the droplet target object. Here, “period during the formation of the droplet target object” refers to the status just before the formation of the droplet target object, the status in the process of formation of the droplet target object, or the status just after the formation of the droplet target object. And, in the present specification, the micro object may be droplets or micro particles of 2 mm or less, or 1 mm or less, or 0.1 mm or less.

1. First Embodiment

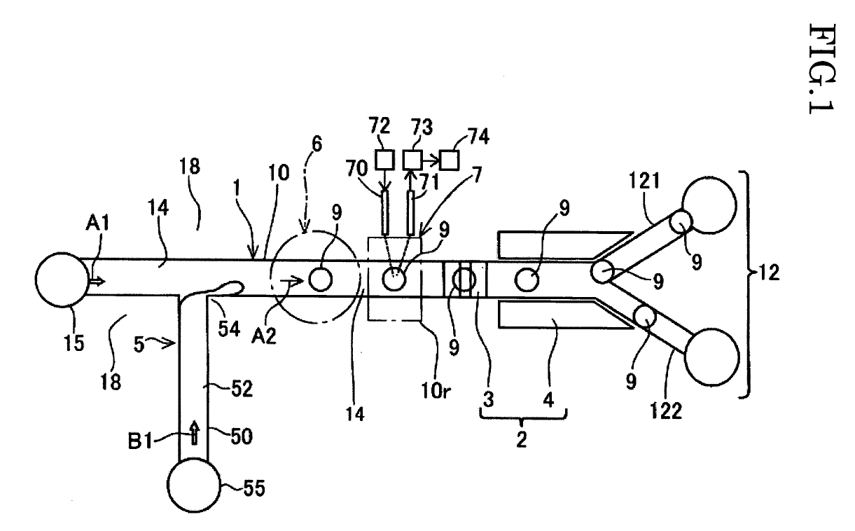

FIG. 1 shows the first embodiment. As shown in FIG. 1, according to a micro liquid control system, a microchannel 1 is provided on a transparent substrate 18 made of resin or glass. The microchannel 1 comprises a main channel 10 which flows a main liquid 14 wherein small size droplets 9 (target object) as a small target object are dispersed and a sorting channel 12 which is provided at the downstream side of the main channel 10 and sorts the target object. At the upstream side of the main channel 10, a pump 15 which discharges the main liquid 14 to the microchannel 1 is provided as a first source. The sorting channel 12 has a Y branch at the downstream side of the main channel 10 to form a first sorting channel 121 and a second sorting channel 122. Also a droplet selecting means 2 (target object selecting means) is provided which selects the droplets 9 which flow in the microchannel and supplies them to the sorting channel 12.

Further, according to the micro liquid control system, as shown in FIG. 1, a droplet forming means 5 (target object forming means) which forms the droplets 9 and flows them to the downstream side, a droplet counting part 6 (target object counting part) which detects and counts the droplet 9 formed by the droplet forming means 5, an information detecting part 7 which performs detection processing of the droplets 9 and detects the information about the droplets 9 which are counted by the droplet counting part 6.

As shown in FIG. 1, the droplet forming means 5 includes a droplet forming channel 50. The droplet forming channel 50 is the channel to flow a parent phase liquid 52 which is the parent phase of the droplets 9 and it intersects with a cross area 54 at the upstream side of the main channel 10 of the microchannel 1. At the upstream side of the droplet forming channel 50, a pump 55 is provided as a second source. The pump 55 discharges the parent phase liquid 52 into the droplet forming channel 50 and flows it in the direction of the arrow B1 (FIG. 1). At the same time, the pump 15 discharges the main liquid 14 into the main channel 10 of the microchannel 1 and flows it in the direction of the arrow A1 (FIG. 1). In this case, the parent phase liquid 52 which is discharged into the main channel 1 at the cross area 54 is separated by the shear force of the main liquid 14 which flow in the main channel 10, and the droplet 9 is formed. The average diameter of the formed droplet 9 (target object) depends on the type of the liquid and may be 1,000 μm or less, or 500 μm or less, or 300 μm or less, and may be 1 to 800 μm, or especially 2 to 500 μm, or 4 to 300 μm. But the size of the droplet 9 is not limited to these values.

The material which contains water as a main component may be adopted as the parent phase liquid 52 of the parent phase of the droplet 9. On the other hand, the material that has a high electric insulating property and low solubility in water may be adopted as the main liquid 14 which severs the flow of the parent phase liquid 52. Hence, the liquid having the hydrophobic property such as oil or fluorocarbon may be adopted as the main liquid 14. The oil may include, for example, sunflower oil, olive oil, tung oil, linseed oil, silicone oil, mineral oil, etc. Since the oil has a rich lubricant property, the pass ability property of the main channel 10 is improved.

The component of the parent phase liquid 52 is water which is electrically conductive and has a larger dielectric constant than that of the main liquid 14 which severs the flow of the parent phase liquid 52. Since the component of the main liquid 14 is oil-based, it is lyophobic against the parent phase liquid 52, that is, hydrophobic. Thus, the formed droplet 9 is a so-called water-in-oil type droplet, for example. The formed droplet 9 flows in the main channel 10 of the microchannel 1 in the direction of the sorting channel 12 (in the direction of the arrow A2) together with the main liquid 14 that flows in the direction of the arrow A2.

When the droplet 9 flows in the microchannel 1 to the downstream side in the direction of the arrow A2, there is the main liquid 14 between two droplets 9. Since the oil-based main liquid 14 has the low solubility in the parent phase liquid 52 which becomes the parent phase of the droplet 9, that is, the hydrophobic property, mixing of the main liquid 14 having mainly the oil component with the droplet 9 having mainly the water component is suppressed. Accordingly, the droplet 9 flows stably toward the downstream direction (direction of the arrow A2).

As shown in FIG. 1, an information detecting part 7 is provided near a detecting position 10r of the main channel 10 of the microchannel 1. The optical detection method is adopted as the information detecting part 7, which comprises optical fibers 70 and 71 whose extremities face the detecting position 10r; a light emitting part 72 including a laser element which emits a laser beam (detecting light) to the other end of the fiber 71 as an electromagnetic wave for excitation; a light receiving part 73 which receives a light irradiated at the droplet 9 (target object) by the laser beam; a detecting part 74 which detects information about the target object based upon a received signal by a light receiving part 73. Since the extremities of the optical fibers 70 and 71 are arranged at the vicinity of the droplet 9 of the detecting position 10r, the main body of the optical system of the information detecting part 7 can be provided away from the droplet 9 where it does not get in the way.

According to the present embodiment, when the liquid flowing in the droplet forming channel 50 is a cell suspension, the droplet 9 containing the cell is formed at the cross area 54 of the droplet forming means 5. And, when the droplet 9 containing the cell flows in the microchannel 1 and arrives at the light converging point of the information detecting part 7, the laser beam emitted from the light emitting part 72 of the information detecting part 7 via the optical fiber 70 as the detecting light is converged on the cell contained in the droplet 9. As the result, a fluorescent material which is supported in advance by the cell is excited by the irradiation of the laser beam. The fluorescent light emitted by the excitation is received via the optical fiber 71 by the light receiving part 73. With this signal, the cell contained in the droplet 9 which has arrived at the detecting position 10r is judged to be a target cell or not by the information detecting part 7. If a detected cell of the droplet 9 is the target cell, the control system issues a target cell signal and the droplet 9 is electrically charged appropriately by the electrical charging part 3. If the detected cell of the droplet 9 is not the target cell, the control system issues a non-intended cell signal.

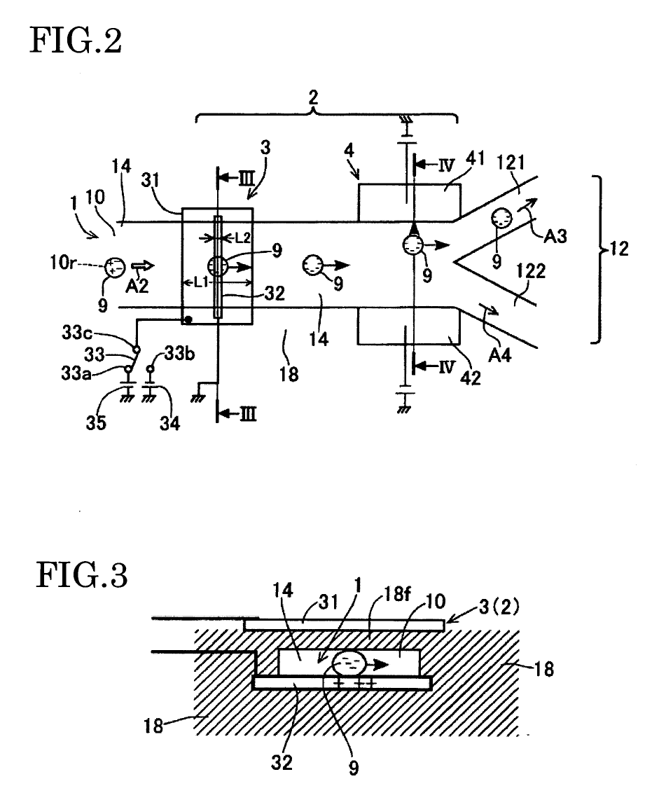

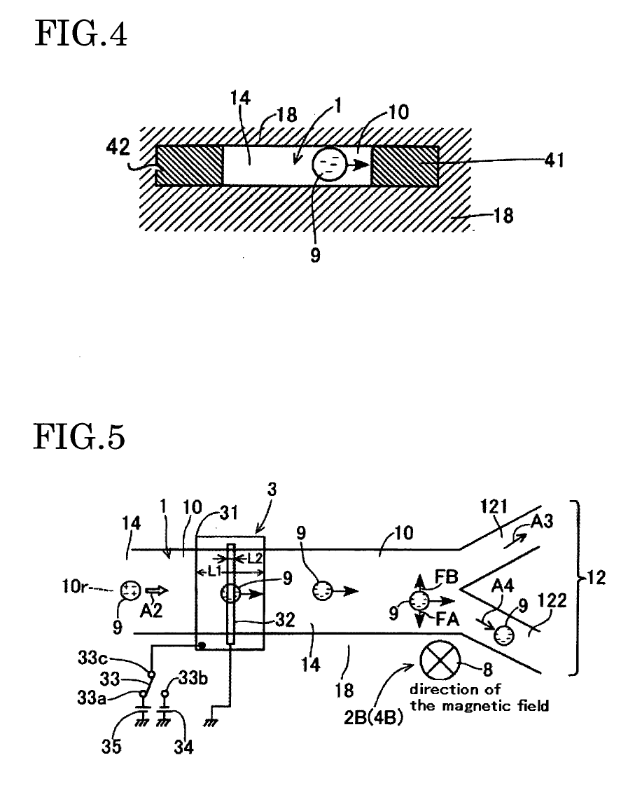

A droplet selecting means 2 is provided at the downstream side of the detecting position 10r in the main channel 10 of the microchannel 1. As shown in FIG. 2, this droplet selecting means 2 comprises an electrical charging part 3 which gives a certain polarity to the droplet 9 which flows toward the downstream side (direction of the arrow A2) in the main channel 10 and a sorter part 4 which sorts individually the droplet 9 according to its polarity.

As shown in FIG. 2, the electrical charging part 3 comprises a combination of a first charging electrode 31 which induces the electrostatic field on the droplet 9 and a second charging electrode 32 which dissipates the charge of the same polarity as that of the first charging electrode. The first charging electrode 31 is connected to charging power sources 34 and 35 through a switch 33. The second charging electrode 32 is connected to the ground. By switching the switch 33, the polarity of the first charging electrode 31 can be changed. Accordingly, the switch 33 can function as the polarity changing means of the first charging electrode 31 for electrostatic induction.

As shown in FIG. 3, the first charging electrode 31 is provided at the top side of the main channel 10 over a cover part 18f and the second charging electrode 32 is provided at the lower side of the main channel 10 where it can make contact with the droplet 9. That is, the first charging electrode 31 is positioned at the outer side of the cover part 18f of the substrate 18 and cannot make contact with the droplet 9. On the other hand, the second charging electrode 32 faces the main channel 10 and can make contact with the droplet 9 in the main channel 10.

As shown in FIG. 2, the sorter part 4 comprises a first selecting electrode 41 and a second selecting electrode 42 which are provided with the distance of the channel width at the opposite sides of the main channel 10. The first selecting electrode 41 has the positive polarity while the second selecting electrode 42 has the negative polarity. But they may not be limited to this polarity arrangement, but may be polarized oppositely.

Further, as shown in FIG. 1, the droplet 9 whose information is detected by the information detecting part 7 continues to flow to the downstream side and arrives at the electrical charging part 3 where the the droplet 9 is set to the positive or negative polarity according to the information described above. That is, the droplet 9 which is detected to have a certain characteristic is set to the negative polarity by the electrical charging part 3. Or, the droplet 9 which is detected to have another characteristic is set to the positive polarity by the electrical charging part 3.

The case where the droplet 9 is set to the negative polarity will now be explained. In this case, as shown in FIG. 2, a terminal 33a is set in a conduction state by the operation of the switch 33. Accordingly, the first charging electrode 31 is set to the positive polarity by a charging source 35. The formed droplet 9 flows along the main channel 10 to the downstream side in the direction of the arrow A2. As can be understood from FIG. 2, this droplet 9 approaches the first charging electrode 31 for electrostatic induction before approaching the second charging electrode 32 for charge dissipation. For this reason, negative charges gather to the part of the droplet 9 which is nearer to the first charging electrode 31 (positive polarity). On the other hand, positive charges gather to the part of the droplet 9 which is far from the first charging electrode 31 (electrostatic induction). When the droplet 9 induced an electrostatic field by electrostatic induction flows to the downstream (in the direction of the arrow A2) and makes contact with the second charging electrode 32 as shown in FIG. 3, the positive charges of the droplet 9 are discharged to the second charging electrode 32. Accordingly, only the negative charges remain on the droplet 9 and the droplet 9 is charged to the negative polarity. As described above, among the charges on the droplet 9, the charges with the same polarity as that of the first charging electrode 31 are discharged to the second charging electrode 32. And, among the charges on the droplet 9, the charges with the opposite polarity to that of the first charging electrode remain on the droplet 9.

In addition, the case where the droplet 9 is set to the positive polarity will now be explained. In this case, the terminal 33b is set in a conduction state by the operation of the switch 33. Accordingly, the first charging electrode 31 is set to the negative polarity by the charging power source 34. The formed droplet 9 flows along the main channel 10 of the microchannel 1 to the downstream side in the direction of the arrow A2. Then, the droplet 9 approaches the first charging electrode 31 for electrostatic induction before approaching the second charging electrode 32 for charge dissipation. For this reason, positive charges gather to the part of the droplet 9 which is nearer to the first charging electrode 31 (negative polarity). On the other hand, negative charges gather to the part of the droplet 9 which is far from the first charging electrode 31. That is, the electrostatic induction occurs on the droplet 9. When the droplet 9 having the electrostatically induced charges flows to the downstream side (in the direction of the arrow A2) and makes contact with the second charging electrode 32, the negative charges of the droplet 9 are discharged to the second charging electrode 32 and only the positive charges remain on the droplet 9 so that the droplet 9 is charged to the positive polarity.

According to the present embodiment, as described above, the droplet 9 approaches the first charging electrode 31 (electrode for electrostatic induction) before approaching the second charging electrode 32 (electrode for charge dissipation). That is, since the undesired charges of the droplet 9 are discharged to the second charging electrode 32 after the electrostatic induction of charges takes place on the droplet 9, it is advantageous to discharge the charges on the droplet 9. Therefore, it becomes advantageous to set the droplet 9 to a desired polarity according to the information related to the droplet 9.

As shown in FIG. 2, in the flow direction of the droplet 9 (direction of the arrow A2), the length of the second charging electrode 32 (L2) is designed to be shorter than that of the first charging electrode 31 (L1). For this reason, even when a plurality of droplets 9 flow (in the direction of the arrow A2) for a short time period, the transfer of the dissipated charge from a downstream droplet 9 to another upstream droplet 9 through the second charging electrode 32 is suppressed. In this sense, it is advantageous to set the droplet 9 to a desired polarity.

According to the present embodiment, as shown in FIG. 2, when the droplet 9 of the predetermined polarity arrives at the sorter part 4 from the electrical charging part 3, the droplet 9 is sorted according to its polarity. That is, if the droplet 9 has the negative polarity, the droplet 9 is attracted by the first selecting electrode 41 (positive polarity, that is, the opposite polarity of that of the droplet 9) by the electrostatic attractive force (Coulomb's force) and flows into a first sorting channel 121 in direction of the arrow A3. In this case, the second selecting electrode 42 has the same polarity as that of the droplet 9 and gives the electrostatic repulsive force (Coulomb's force) to the droplet 9 to make it flow into a first sorting channel 121.

On the other hand, if the droplet has the positive polarity, when the droplet 9 arrives at the sorter part 4, the droplet 9 is attracted by the second selecting electrode 42 (negative polarity, that is, the opposite polarity of that of the droplet) by the electrostatic attractive force (Coulomb's force) and flows into a second sorting channel 122 in the direction of the arrow A4. In this case, since the polarity of the first selecting electrode 41 is the same as that of the droplet 9, the electrostatic repulsive force (Coulomb's force) also contributes and it is considered that the droplet 9 is sorted into the second sorting channel 122.

As described above, each droplet 9 can be sorted in units into the first sorting channel 121 or into the second sorting channel 122 according to the information of the droplet 9 of the target object. With this, it becomes possible to sort the droplet 9 in units of nano-liter, pico-liter, or femto-liter, etc.

Accordingly, if the droplet 9 is a droplet which contains a fine particle such as a cell etc., the fine particle of the cell etc. can be kept inside a liquid parent phase of the droplet 9, and the droplet 9 can be sorted in units into the first sorting channel 121 or into the second sorting channel 122, and the diffusion of the fine particle such as the cell etc. to the outside of the droplet 9 is suppressed.

According to the above-described present embodiment, the method is adopted wherein the droplet 9 is flown to the downstream together with the main liquid 14 of liquid phase. Compared to the prior art related to the patent document 1, the transportation speed of the droplet 9 is higher and it is advantageous from the point of high speed and large quantity processing. In addition, compared to the prior art related to the patent document 2, the valve is not used to control the flow and the valve-less liquid system is possible. Thus, the malfunction such as flow stagnation or clogging due to the valve can be suppressed. In addition, compared to the prior art related to the patent document 3, since the insulating property of the main liquid 14 is high, the heating of the main liquid 14 can be suppressed.

Further, according to the micro liquid control system related to the first embodiment of the present invention, the voltage of the opposite or the same polarity as that of the target object is applied to the target object. With this arrangement, the electrode of the target object selecting means moves the target object by the attractive or repulsive force to select the target object.

2. Second Embodiment

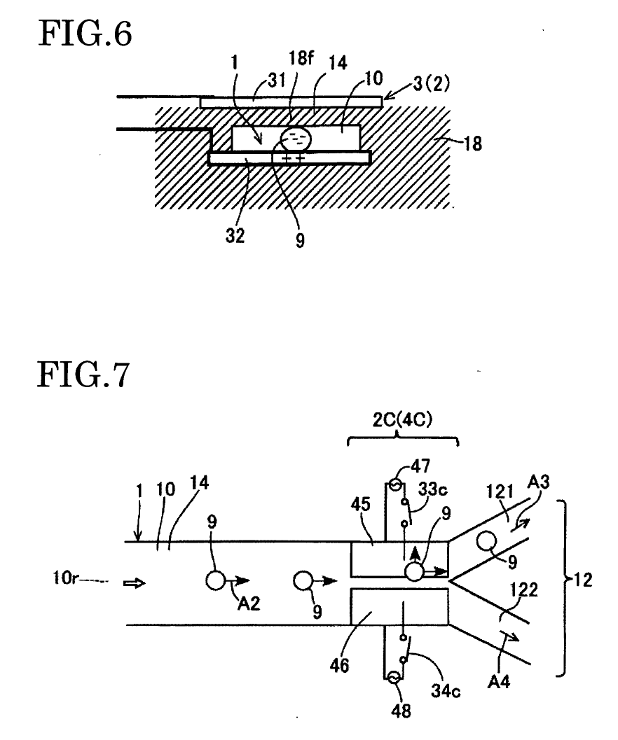

FIGS. 5 and 6 show the second embodiment. Also, in this embodiment, in a manner similar to the first embodiment shown in FIG. 1, a droplet forming means 5, a droplet counting part 6 and an information detecting part 7 are provided at the upstream side of a main channel 10 of a microchannel 1. Since the configuration and its function are the same as those of the embodiment 1, the description and the figure will not be repeated here. The common part has basically the common reference numeral.

According to a micro liquid control system of this embodiment, as shown in FIG. 5, the microchannel 1 comprises the main channel 10 to flow a main liquid 14 in which a fine size droplet 9 is dispersed and a sorting channel 12 which sorts the droplet 9 at the downstream side of the main channel 10. The sorting channel 12 has a Y branch at the downstream side of the main channel 10 and comprises a first sorting channel 121 and a second sorting channel 122. In addition, a droplet selecting means 2B, which functions as a selecting means of a target object to select the droplet 9 and supply it into the sorting channel 12, is provided.

The droplet selecting means 2B is provided at the downstream side of the above-described detecting position 10r. The droplet selecting means 2B comprises an electrical charging part 3 (FIG. 6) which gives the polarity to the droplet 9 flowing toward the downstream side (direction of the arrow A2) in the main channel 10 and a sorter part 4B (FIG. 5) which sorts the droplet 9 having the polarity given by the electrical charging part 3.

The description of the configuration and function of an electrical charging part 3 will not be repeated here, as it is the same as that of the embodiment 1. The sorter part 4B comprises a magnetic field generating part 8. The magnetic field generating part 8 is provided at the downstream side of the electrical charging part 3 and it applies the electromagnetic force to the droplet 9 charged by the electrical charging part 3. With this, the droplet 9 is moved and is sorted into the sorting channel 12.

According to the present embodiment, in case where the droplet 9 is charged with the negative polarity, as shown in FIG. 5, the magnetic field generating part 8 generates the magnetic field which is perpendicular to the main channel 10 of the microchannel 1. That is, it generates the magnetic field which is perpendicular to the paper surface of FIG. 5 and in the direction from the upper side of the paper to the lower side. With this, according to Fleming's left-hand rule, the magnetic force of the direction of the arrow FA is applied to the droplet 9. Accordingly, the droplet 9 flows into the sorting channel 122 in the direction of the arrow A4 and is sorted in the sorting channel 122.

On the other hand, if the droplet 9 has the positive polarity, the magnetic field generating part 8 generates the magnetic field in the same direction as the above and applies the electromagnetic force of the direction of FB.

As described above, when the magnetic field generating part 8 generates the magnetic filed of the predetermined direction by the control system according to the polarity of the droplet 9 of the target object, the droplet 9 can be sorted into the first sorting channel 121 or into the second sorting channel 122.

That is, according to the target object droplet 9, the droplet 9 is sorted in units into the sorting channel 121 or into the sorting channel 122. With this, it becomes possible to sort the droplet 9 in units of nano-liter, pico-liter, or femto-liter, etc.

In addition, if the droplet is a droplet which contains a fine particle such as a cell etc., the fine particle of the cell etc. can be kept inside a liquid parent phase of the droplet 9, and the droplet 9 is sorted into the first sorting channel 121 or into the second sorting channel 122 in units and the diffusion of the fine particle such as the cell etc. to the outside of the droplet is suppressed.

Also, according to the present embodiment, the method is adopted wherein the droplet 9 is flown together with the main liquid 14 of the liquid phase. And, compared to the prior art related to the patent document 1, the transportation speed is higher and it is advantageous from the point of high speed, large quantity processing. In addition, compared to the prior art related to the patent document 2, an opening or closing valve is not used to control the flow and a valve-less liquid system is possible. Thus, the malfunction such as flow stagnation or clogging can be suppressed. In addition, compared to the prior art related to the patent document 3, since the insulating property of a main liquid 14 is high, the heating of the main liquid 14 can be suppressed.

Further, according to the micro liquid control system related to the second embodiment of the present invention, the target object flowing in the microchannel is electrically charged by the charging part of the target object selecting means. The magnetic field generating part which is provided at the downstream side of the charging part applies the electromagnetic force to the charged target object to move and selects the target object in units.

3. Third Embodiment

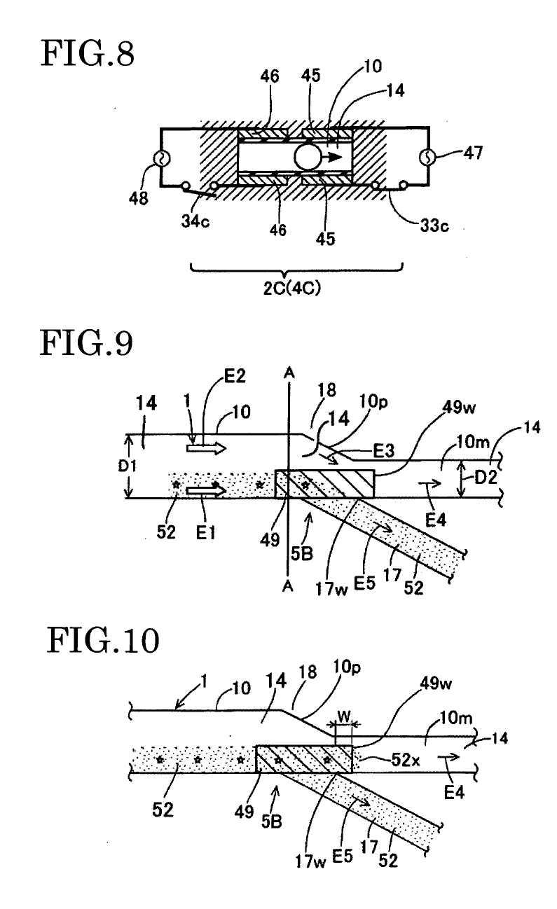

FIGS. 7 and 8 show the third embodiment. Also, in this embodiment, in a manner similar to the first embodiment as shown in FIG. 1, a droplet forming means 5, a droplet counting part 6 and an information detecting part 7 are provided at the upstream side of a main channel 10 of a microchannel 1. As the configuration and its function are the same as those of the embodiment 1, the description and the figure will not be repeated here. The common part has basically the common reference numeral.

According to a micro liquid control system related to the present embodiment, as shown in FIG. 7, the microchannel 1 comprises the main channel 10 to flow a main liquid 14 in which a fine size droplet 9 is dispersed and a sorting channel 12 which sorts the droplet 9 at the downstream side of the main channel 10.

The sorting channel 12 has a Y branch at the downstream side of the main channel 10 and comprises a first sorting channel 121 and a second sorting channel 122. In addition, a droplet selecting means 2C which functions as a selecting means of a target object selects the droplet 9 and supplies it into the sorting channel 12. In the present embodiment, there is no electrical charging part 3 which compulsorily charges the droplet 9.

The droplet selecting means 2C is provided at the downstream side of a detecting position 10r in the main channel 10. The droplet selecting means 2C is formed as shown in FIG. 7, where a first deflected electrode 45 and a second deflected electrode 46 are provided face to face at the both side of the main channel 10 of the microchannel 1.

As shown in FIG. 8, the first deflected electrode 45 is connected to a first power source 47 (AC power source) through a switch 33c and it comprises one pair of electrodes which sandwich the main channel 10 in the vertical direction. The second deflected electrode 46 is connected to a second power source 48 (AC power source) through a switch 34c and it comprises one pair of electrodes which sandwich the main channel 10 in the vertical direction.

According to the present embodiment, the dielectric constant of the droplet 9 is higher than that of the main liquid 14 and the difference is large. For example, the droplet 9 may be water-based and the main liquid 14 may be oil-based such as silicone oil etc. If the droplet 9 is to be sorted into the first sorting channel 121, the switch 33c is turned on to apply AC voltage to the first deflected electrode 45 from the first power source 47 and the AC electric field (electrostatic field) is generated. In this case, the switch 34c is turned off and the AC power is not applied to the second deflected electrode 46.

In this situation, the droplet 9 flows downstream in the direction of the arrow A2 in the main channel 10 of the microchannel 1, and when it arrives at a sorter part 4C, the water-based droplet 9 with the higher dielectric constant is attracted toward the inside of the first deflected electrode 45 and flows in the direction of the arrow A3 to be sorted in the first sorting channel 121.

When the dielectric constant of the droplet 9 is higher than that of the main liquid 14 and when the voltage is applied on the first deflected electrode 45, the reason why the droplet 9 is attracted toward the inside of the first deflected electrode 45 is conjectured to be due to Maxwell stresses. The electric field, that is, the electric field line, has the stress to shrink in the direction parallel to the electric field and also has the stress to expand in the direction perpendicular to the electric field. This stress is called Maxwell stresses. The magnitude of this stress is determined basically by the strength of the electric field and the value of the dielectric constant. When liquids with different dielectric constants coexist between the electrodes, the stress to expand in the direction perpendicular to the electric field is larger for the liquid which has the larger dielectric constant. Accordingly, it is inferred that the droplet 9 that has a larger dielectric constant is given the attraction force toward the inside of the electrode gap by Maxwell stresses. Hereafter, in this specification, the force by which the parent phase liquid is attracted toward the inside of the electrode gap is called “the attraction force by the electric field”.

In addition, when the droplet 9 is to be sorted into the second sorting channel 122, the switch 34c is turned on and the AC voltage is applied to the second deflected electrode 46 from the second power source 48. In this case, the switch 33c is turned off and the voltage is not applied to the first deflected electrode 45 from the first power source 47. In this situation, the droplet 9 flows downstream in the direction of the arrow A2 in the main channel 10 of the microchannel 1, and when it arrives at the sorter part 4C, the water droplet 9 with the higher dielectric constant is attracted toward the inside of the second deflected electrode 46 by “the attraction force by the electric field” and flows in the direction of the arrow A4 to be sorted in the second sorting channel 122.

As described above, the target object of the droplet 9 can be sorted into the first sorting channel 121 or into the second sorting channel 122 by the application of the AC voltage on the first deflected electrode 45 or the second deflected electrode 46, respectively, according to the information on the droplet 9 detected by an information detecting part 7.

Namely, the droplet 9 can be sorted in units into the first sorting channel 121 or into the second sorting channel 122 depending on the droplet 9 of the target object. With this, it becomes possible to sort the droplet 9 in units of nano-liter, pico-liter, or femto-liter, etc. Accordingly, if the droplet is a droplet which contains a fine particle such as a cell etc., the fine particle of the cell etc. can be kept inside a liquid parent phase of the droplet 9, and the droplet 9 is sorted in units into the first sorting channel 121 or into the second sorting channel 122, and the diffusion of the fine particle such as the cell etc. to the outside of the droplet 9 is suppressed.

Also, according to the present embodiment, the method is adopted wherein the droplet 9 is flown together with the main liquid 14 of the liquid phase. And, compared to the prior art related to the patent document 1, the transportation speed is higher and it is advantageous from the point of high speed, large quantity processing. In addition, compared to the prior art related to the patent document 2, an opening or closing valve is not used to control the flow and a valve-less liquid system is possible. Thus, the malfunction such as flow stagnation or clogging can be suppressed. In addition, compared to the prior art related to the patent document 3, since the insulating property of the main liquid 14 is high, the heating of the main liquid 14 can be suppressed.

Further, according to the micro liquid control system related to the third aspect of the present invention, when the dielectric constant of the target object is higher than that of the main liquid, the voltage applied electrode attracts the target object and moves it. With this force, the electrode selects the target object in units.

Other Droplet Forming Means 5

FIGS. 9 to 12 show the schematic diagram illustrating the plane view of another droplet forming means 5B which functions as a target object forming means. FIG. 12 shows the view taken along the line A-A of FIG. 9. As shown in FIGS. 9 to 11, a main channel 10 of a liquid channel 1 comprises the main channel 10 with the channel width (D1) provided at the upstream side, a narrow channel 10m with the channel width (D2) which is narrower than the width (D1), an oblique guide surface 10p which is formed at the border between the main channel 10 and the narrow channel 10m. The droplet forming means 5B comprises a branch channel 17 which is branched in the microchannel 1 forming a Y shape, and a deflected electrode 49 which is provided, facing to the main channel 10, at the side of the branch channel 17 and generates “the attraction force by the electric field”.

Also, as shown in FIG. 12, the deflected electrode 49 is connected to a power source 59 through a switch 58 and comprises a pair of electrodes which sandwich the main channel 10 from the upper and the lower sides. In the state shown in FIG. 9, the voltage is not applied on the deflected electrode 49.

When the voltage is not applied on the deflected electrode 49 as shown in FIG. 9, a parent phase liquid 52 (for example, water) which becomes a parent phase of the droplet 9 flows in one side of the width of the main channel 10 (the side of the branch channel 17 and the side of the electrode) in the direction of the arrow E1 in the microchannel 1. In addition, a main liquid 14 (for example, oil phase) flows in the other side of the width of the main channel 10 (the opposite side from the branch channel 17 and the opposite side from the electrode) in the direction of the arrow E2. In this case, the main liquid 14 is forced to flow in the direction of the arrow E3 by the guiding function of the oblique guide surface 10p, enters into the narrow channel 10m of the microchannel 1, and continues to flow in the narrow channel 10m in the direction of arrow E4. With the this effect, the parent phase liquid 52 which becomes the parent phase of the droplet 9 flows basically from one side of the main channel 10 into the branch channel 17 in the direction of the arrow E5. Here the dielectric constant of the parent phase liquid 52 is set to be higher than that of the main liquid 14 and its difference is large. For example, the parent phase liquid 52 is water-based and the main liquid 14 is oil-based.

When the droplet is to be formed, the voltage is applied on the deflected electrode 49. Then, “the attraction force by the electric field” is generated which attracts the material of a higher dielectric constant toward the side of the deflected electrode 49. Here, as shown in FIG. 10, the downstream edge 49w of the deflected electrode 49 is extended by the size of W to the downstream side from the branch point 17w of the main channel 10 and the branch channel 17.

Accordingly, as shown in FIG. 10, although the parent phase liquid 52 having a larger dielectric constant flows from the main channel 10 to the branch channel 17, some fraction 52x is attracted to face the downstream edge 49w of the deflected electrode 49 with “the attraction force by the electric field” generated by the deflected electrode 49 and is sucked to the downstream side of the main channel 10 from the branch point 17w. As the result, as shown in FIG. 10, some fraction 52x of the parent phase liquid 52 moves to the further downstream side from the branch point 17w of the branch channel 17 in the microchannel 1 in the direction of the arrow E4 and is about to enter into the narrow channel 10m.

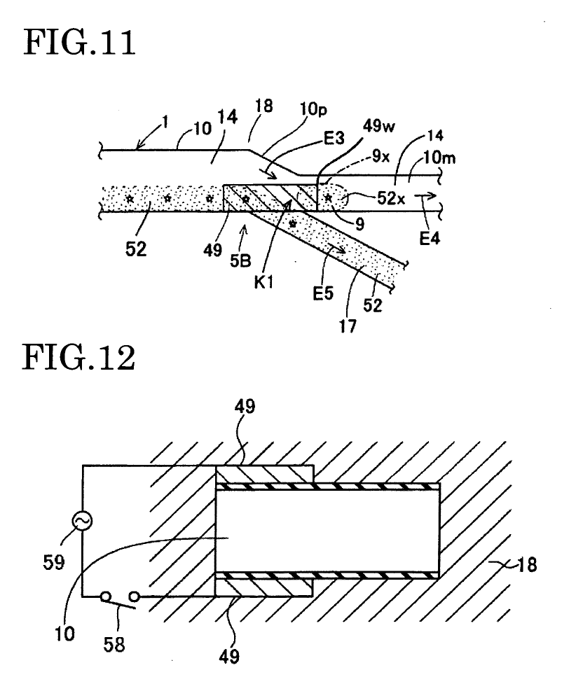

In this condition, when the voltage applied to the deflected electrode 49 is turned off, “the attraction force by the electric field” generated by the deflected electrode 49, that is, the force, which attracts a liquid of a larger dielectric constant, essentially disappears. For this reason, the flow direction of the main liquid 14 goes back to the state shown in FIG. 9. That is, the parent phase liquid 52 is forced to flow in the direction of the arrow E3 by the oblique guide surface 10p and enters into the parent phase liquid 52. Accordingly, the fraction 52x of the parent phase liquid 52 which is about to enter into the narrow channel 10 is severed by the main liquid 14 at the severed point K1 (FIG. 11), and the droplet 9 is formed. The formed droplet 9 flows together with the main liquid 14 in the narrow channel 10m to the downstream side in the direction of the arrow E4. As described above, with the repetition of on and off of the application voltage on the deflected electrode 49, the droplet 9 is formed intermittently and it flows in the narrow channel 10m to the downstream side in the direction of the arrow E4. In FIG. 11, the profile 9x of the droplet 9 is shown.

Droplet Counting Part 6

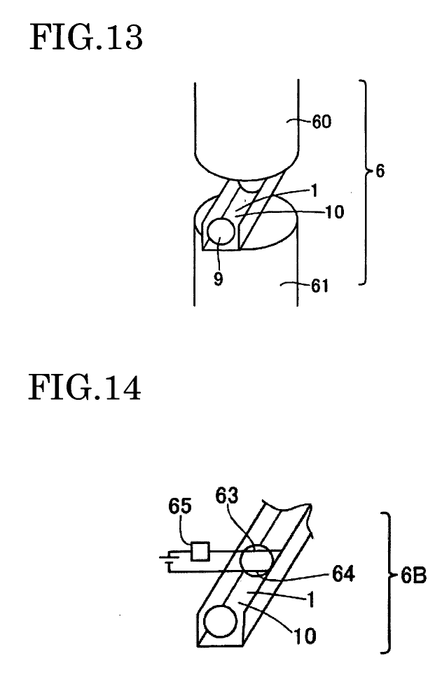

FIG. 13 shows one example of the above-described droplet counting part 6. The droplet counting part 6, light transmission-type, detects the droplet 9 which is severed by the droplet forming means 5 and counts the number of the droplet 9. The droplet counting part 6 comprises a light sending part 60 and a light receiving part 61 which sandwich the main channel 10 of the microchannel 1 where the droplet 9 flows. When there is no droplet 9, the light projected by the light sending part 60 is transmitted to the side of the light receiving part 61 and received by the light receiving part 61. When the droplet 9 exists between the light sending part 60 and the light receiving part 61, the light transmission is severed or an amount of transmitted light decreases. Thus, the number of the droplet can be counted by detecting this. In this case, the light transmission-type method is adopted, but also the light reflection-type method which utilizes the inspecting light reflected by the droplet 9 may be adopted. In addition, the light reflection-type method may be adopted where a reflection mirror is provided at the opposite side of the light sending part 60 through the main channel 10.

FIG. 14 shows another example of the droplet counting part 6B. The droplet counting part 6B detects the droplet 9 that is severed by the droplet forming means 5 and counts the number of droplets 9. The droplet counting part 6B comprises a first electrically conductive part 63 and a second electrically conductive part 64 which are provided face to face with some distance between them in the main channel 10 of the microchannel 1 where the droplet 9 flows.

The droplet 9 is electrically conductive. The main liquid 14 has an electrically insulating property. Accordingly, when there is no droplet 9 between the first electrically conducting part 63 and the second electrically insulating part 64, the first electrically conducting part 63 and the second electrically insulating part 64 is nonconductive. When there is the droplet 9 between the first electrically conducting part 63 and the second electrically insulating part 64, the first electrically conducting part 63 and the second electrically insulating part 64 becomes conductive through the droplet 9. Accordingly, the existence of the droplet 9 is detected by the detecting part 65. The number of droplets 9 can be measured by counting the number of conducting events.

4. Fourth Embodiment

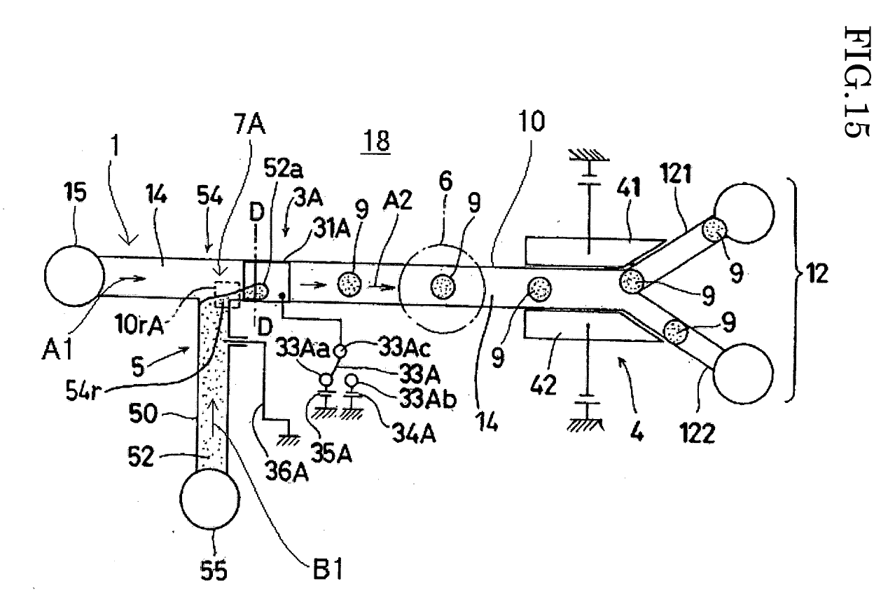

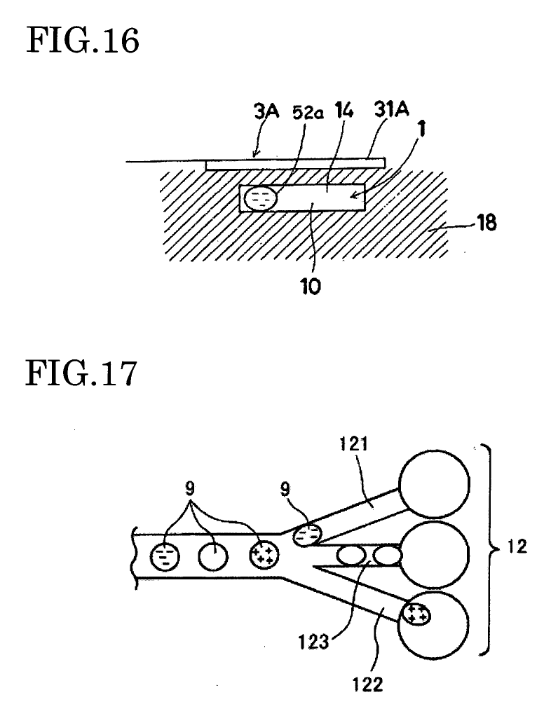

FIG. 15 shows a micro liquid control system of the fourth embodiment. FIG. 16 shows the sectional view taken along the line D-D of FIG. 15. The micro liquid control system of the present embodiment comprises a droplet forming means 5, a droplet counting part 6 which counts formed droplets 9, and a sorter part 4 which sorts the droplet 9. Also, it comprises an electrical charging part 3A which charges the droplet 9. The electrical charging part 3A is provided at the upstream side of the droplet counting part 6 and this is the different point from that of the micro liquid control system shown in FIG. 1.

Furthermore, when the droplet 9 is formed by the droplet forming means 5, the electrical charging part 3A charges an extremity part 52a just before the droplet 9 is formed during the forming process of the droplet 9 (a state before the droplet 9 is severed), and this process is the different point from that of the micro liquid control system shown in FIG. 1. Since the droplet counting part 6 and the sorter part 4 are basically the same as those shown in FIG. 1, the same reference numerals are assigned and the detailed explanation is not repeated here.

In the present embodiment, the electrical charging part 3A is provided at the downstream side of a cross area 54 of the droplet forming means 5 and at the upstream side of a droplet counting part 6 very close to the cross area 54. The electrical charging part 3A has an charging electrode 31A. This charging electrode 31A can be connected to a power source 34A or 35A through a switch 33A. When a terminal 33Aa and a terminal 33Ac are connected by the switch 33A, the polarity of the charging electrode 31A becomes positive by the power source 35A. On the other hand, when the terminal 33Ab and the terminal 33Ac are connected by the switch 33A, the polarity of the charging electrode 31A becomes negative by the power source 34A. Accordingly, the switch 33A operates as a polarity switching means of the charging electrode 31A.

In addition, the charging electrode 31A is provided, as shown in FIG. 16, over a microchannel 1 (especially a main channel 10). That is, as shown in FIG. 15, a parent phase liquid 52 entering from a droplet forming channel 50 into the cross area 54 is pushed by a main liquid 14 in the microchannel 1, and when the extremity part 52a of the parent phase liquid 52 takes a position just below the downstream side of the cross area 54 in the main channel 10, the charging electrode 31A is arranged to be right above the extremity part 52a of the parent phase liquid 52.

In addition, as shown in FIG. 15, in the droplet forming channel 50 of the droplet forming means 5, one end of a terminal 36A is arranged to make contact with the parent phase liquid 52 in the droplet forming channel 50 and the other end of the terminal 36A is connected to the ground. Accordingly, the parent phase liquid 52 in the droplet forming channel 50 is connected to the ground through the terminal 36A.

According to the present embodiment, during the formation of the droplet 9, the extremity part 52a, immediately before the droplet 9 is formed, can be electrically charged by the charging electrode 31A. Also, the polarity of the charge of the droplet 9 can be selected to be positive or negative by changing the polarity of the charging electrode 31A.

Hereinafter, more specifically, the operation of the electrical charging part 3A will be explained. The parent phase liquid 52 may be, for example, a cell suspension containing a cell. When the cell contained in the parent phase liquid 52 entering into the cross area 54 is a target cell which has a special characteristic, the droplet 9 is charged to be positive or negative.

Here, the case will be explained where the droplet 9 is charged to be negative when the cell is the target cell having the special characteristic. The charging electrode 31A is positive by the connection to the power source 35A through the switch 33A. With this, when the extremity part 52a of the parent phase liquid 52 entering into the cross area 54 approaches the charging electrode 31A, the part of the extremity part 52a which faces the charging electrode 31A tends to become negative by electrostatic induction. In addition, the part which is far from the charging electrode 31A tends to become positive. Here, the parent phase liquid 52 which passes the droplet forming channel 50 is connected to the ground through the terminal 36A, and the excessive positive charges (the charge with the same polarity as that of the charging electrode 31A) remaining in the extremity part 52a escape to the terminal 36A through the parent phase liquid 52 in the droplet forming channel 50 (charge discharge mechanism). Therefore, the extremity part 52a just before being severed has the negative polarity. As a result, the droplet 9 has the negative polarity after severed.

In addition, when no cell having a special characteristic is contained in the parent phase liquid 52 entering into the cross area 54, the charging electrode 31A is connected to the power source 34A through the switch 33A and the polarity of the charging electrode 31A becomes negative. Accordingly the extremity part 52a just before being severed has the positive polarity and the droplet 9 has the positive polarity after severed.

Furthermore, in the above description, the droplet 9 is charged to the negative polarity when the cell is the target cell which has the special characteristic and the droplet 9 is charged to the positive polarity when the cell is not the target, but the opposite polarity assignment may be adopted as well.

By the way, whether the cell contained in the parent phase liquid 52 entering into the cross area 54 is the target cell having a special characteristic or not is judged by the information detecting part 7A provided at the detecting position 10rA near the cross area 54. This information detecting part 7A has basically the same structure as the information detecting part 7 shown in FIG. 1. However, it is different from the information detecting part 7, shown in FIG. 1, in which inspecting light is irradiated onto the cell contained inside the droplet 9. By contrast, in this case, the inspecting light is projected to the cell contained in the extremity part 52a just before being severed or to the cell contained in the parent phase liquid 52 before being transferred to the extremity part 52a.

In addition, according to the present embodiment, as described above, whether the cell included in the parent phase liquid 52 is the target object having a special characteristic or not is detected by the information detecting part 7A provided at the detecting position 10rA near the cross area 54. Here, when the cell contained in the parent phase liquid 52 is the target cell, the charging electrode 31A is connected to the power source 35A or 34A by the operation of the switch 33A and the positive or negative charge is applied to the charging electrode 31A.

In this case, according to the present embodiment, the parent phase liquid 52 itself in the droplet forming channel 50 is connected to the ground by the terminal 36A, and this means that the extremity part 52a just before being severed is grounded to the terminal 36A through the parent phase liquid 52 in the droplet forming channel 50. Therefore, the excessive charge of the extremity part 52a or the cell contained in the extremity part 52a which has the same polarity as that of the charging electrode 31A can be dissipated through the terminal 36A.

As described above, the installation of the charge dissipation electrode (the electrode 32 shown in FIG. 2) facing to the charging electrode 31A is not necessary because the excessive charge remaining in the extremity part 52a just before being severed is discharged through the terminal 36A. This means that it is not necessary for the droplet 9 to make contact with the charge dissipation electrode (the electrode 32 shown in FIG. 2). This has the advantage in that it is not necessary to control the size of the droplet 9 precisely.

In addition, in order to change the polarity of charges depending on whether it is the target cell or not, the information detecting part 7 which detects whether it is the target cell or not must be provided at the upstream side of the charging electrode 31A which charges the extremity part 52a. For this reason, according to the present invention as shown in FIG. 15, the information detecting part 7A is arranged at the detecting position 10rA near the cross area 54 at the upstream side of the charging electrode 31A. And the inspecting light irradiates a narrow liquid width area 54r of the detecting position 10rA where the liquid width is narrowed to be severed. Since the narrow liquid width area 54r is irradiated by the inspecting light, a fluctuation of the cell position in the direction of the liquid width is suppressed and hence a cell detection fluctuation is suppressed.

Sorting Channel 12

In addition, when the method to charge the droplet and sort it according to the polarity of the droplet is adopted, according to the embodiment 1 and the embodiment 2, the droplet 9 of the target object is charged with one polarity and the droplet 9 which is not the target object is charged with the opposite polarity. When this method is adopted, with the increasing number of droplets formed per unit time, the spacing between two adjacent droplets becomes small and there may be the possibility that the droplets themselves repulse or attract each other with the influence of the charges of the droplets. As the result, the droplets 9 may be combined or the flow is disturbed, and a sorting error may result. Therefore, according to the present invention, only the droplet 9 of the target object can be charged or only the droplet 9 of the non-target object can be charged. With this arrangement, the above-described problem can be solved.

Specifically, when two sorting channels 12 which sort the droplet 9 are formed as shown in FIG. 2 or 5, the channel resistance (the pressure loss from the branch of the sorting channel 12 of the main channel 10 to the exit of the sorting channel 12: hereinafter referred to simply as pressure loss) of one sorting channel is made smaller than the channel resistance (pressure loss) of the other sorting channel. Accordingly, normally, the droplet 9 with no electric charge flows into the sorting channel having a smaller liquid pass resistance (pressure loss). With this, only the droplet 9 of the target object is charged and only this droplet 9 can be sorted. Or, the droplet 9 of the non-target object is charged and this droplet 9 can be sorted.

With the above-described configuration, the quantity of droplets 9 which are not charged increases, and as the result, the probability that charged droplets 9 are in the neighborhood of other charged droplets 9 decreases. Accordingly, the possibility that the charged droplets 9 are influenced with the other charged droplets 9 decreases. For this reason, even when the number of droplets formed in unit time increases, the possibility of causing a sorting error decreases. The different channel resistance (pressure loss) for each channel can be realized by using a tube with a different diameter at the exit of the sorting channel 12 or by changing the channel width of the sorting channel 12.

Furthermore, when the sorting method of the charged droplet 9 is adopted as shown in FIGS. 2 and 5, three or more sorting channels of the droplet 9 may be provided. FIG. 17 shows the branch area around the sorting channel 12 where the three sorting channels 12 are provided to sort the droplet 9. The sorting channel 12 shown in FIG. 17 shows that a third sorting channel 123 is formed between the sorting channels 121 and 122 of the same type as those of FIGS. 2 and 5. In this case, the droplet 9 having a certain characteristic may be charged to the positive polarity by the charging electrodes 31 and 32, the droplet 9 having another characteristic may be charged to the negative polarity, and the droplet 9 having another characteristic or having non-target object may have no charge. With this configuration, according to the first embodiment shown in FIG. 2, the droplet 9 with the positive or negative polarity is given the attractive or repelling force by at least one of the selecting electrode 41 or 42 and is sorted into the sorting channels 121 and 122 of opposite directions. On the other hand, the droplet 9 which has no charge flows into the sorting channel 123 at the center among the three channels.

On the other hand, in the second embodiment shown in FIG. 5, the droplet 9 which is charged to the positive or negative polarity receives the electromagnetic force by the magnetic field generating part 8 and is sorted into the sorting channels 121 and 122 of opposite directions. Accordingly, the number of the species of samples which can be sorted by one operation can be two or three. In addition, according to this embodiment, the number of droplets 9 which have no charge increases as the result, and even when the number of droplets formed per unit time increases, the possibility of causing a sorting error can be suppressed.

Further, the number of the sorting channels 12 is not necessarily limited to 3. The sorting channels 12 can be 4 or more. In this case, the charge amount given to the droplet 9 may be controlled by the charging electrodes 31 and 32. As the result, the attractive force or repulsive force by the selecting electrodes 41 or 42 or the electromagnetic force by the magnetic field generating part 8 acting on the droplet 9 is controlled, and the droplet 9 can be sorted into each sorting channel.

(Others)

As described above, in case where the parent phase liquid 52 flowing in the droplet forming channel 50 as shown in FIG. 1 includes a plurality of fine particles, when the droplet 9 is formed near the cross area 54, the plurality of fine particles may be contained in the droplet 9. Thus, the droplet 9 containing the plurality of fine particles can be formed. The fine particles may be either fine powder particles or cells. The fine powder particles may include, for example, resin-based, metal-based or ceramic-based. The cells, in addition to a cell itself, may include, for example, cell constituent material, cell related material, organella, blood cell (leucocyte, erythrocyte, blood platelet etc.), animal cell (culture cell, isolated tissue, etc.), vegetable cell, microbe (bacteria, protozoan, fungi, etc.), marine organism (plankton etc.), sperm, yeast, mitochondria, nucleus, protein, nucleic acid such as DNA, RNA, etc., or antibody etc.

Accordingly, the parent phase liquid 52 flowing in the droplet forming channel 50 shown in FIG. 1 may include cell suspension. The cell suspension refers to a liquid which contains cells, and comprises a liquid component and many cells contained in the liquid component. This liquid component may include, for example, a cell buffering solution, a physiological salt solution, a cell isotonic solution, a culture solution, etc. The liquid which does not make clogging is preferable. In general, the cell is hydrophilic, and a liquid having a hydrophilic property can be adopted as the liquid component to constitute the cell suspension.

As the information detecting part 7 described above, the configuration can be adopted wherein the electromagnetic wave is irradiated to the droplet 9 containing the fine particles and flowing in the main channel 10, and the information of the fine particle contained in the droplet 9 is detected. As the electromagnetic wave, light may be adopted. As the light, the laser beam is preferable because of the excellent directivity, and the direction, wavelength and intensity of the light thereof are highly constant. The laser beam may include, for example, Argon laser, He—Ne laser, He—Cd laser, Ga—Al laser, etc. As for the information of the fine particle, any information that can be obtained by the irradiation of the electromagnetic wave is accepted. For example, when the scattered light is received with the irradiation of the electromagnetic wave, information about the density, dimension, etc. of the fine particle is obtained. When the electromagnetic wave is irradiated as excitation light and a fluorescent state is observed, the information about the expression state etc. of the fine particles such as cells etc. is likely to be obtained. Therefore, preferably the configuration of the information detecting part 7 can be adopted wherein the electromagnetic wave such as a laser beam is irradiated to the droplet 9 flowing in the main channel 10 and containing the fine particles such as cells etc., the fluorescent light etc. from the fine particles such as the cells etc. contained in the droplet 9 which contains the fine particles such as liquid drops containing the cells etc. is detected, and the information related to the fine particles such as the cells etc. is detected based upon the fluorescent light etc. In this case, the material which emits the fluorescent light when it is excited can be carried in advance by the fine particle such as the cells etc. In FIG. 1, the droplet counting part 6 is provided at the upstream side of the information detecting part 7, but it may be provided at the downstream side of the information detecting part 7. In addition, the present invention is not limited to the above-mentioned embodiments, and the above-described switch may include, for example, a switching element of mechanical on/off type, a semiconductor switching element such as transistors, operational amplifiers, etc. and the like. Many apparently widely different embodiments of the present invention can be made without departing from the spirit and scope thereof.

1. A micro liquid control system comprising:
a microchannnel including a main channel to flow a main liquid in which fine target objects are dispersed and a sorting channel which, situated at the downstream side of the main channel, sorts the target objects; and
a target object selecting means which selects the target objects flowing in the microchannel and supplies them to the sorting channel,
wherein the target object selecting means is provided with an electrode which moves the target objects with the attractive or repulsive force by applying a voltage with the opposite or the same polarity as that of the target objects and selects the target objects.

2. The micro liquid control system according to the claim 1, wherein the target object selecting means comprises an electrical charging part which charges the target objects flowing in the microchannel at the upstream side of the electrode.

3. The micro liquid control system according to the claim 2, wherein a target object forming means to form the target objects is provided at the upstream side of the target object selecting means in the microchannel; and
the electrical charging part charges the target objects after the formation of a droplet of the target objects by the target object forming means.

4. The micro liquid control system according to the claim 3, wherein the electrical charging part comprises a first charging electrode, which induces an electrostatic field on the target objects flowing in the main channel of the microchannel, and a second charging electrode, which makes contact with the target objects flowing in the main channel of the microchannel and induced an electrostatic field, and dissipates the charge of the same polarity as that of the first electrode through this contact.

5. The micro liquid control system according to the claim 4, wherein, in the direction of flow of the target objects, the length of the second charging electrode is set to be shorter than that of the first charging electrode.

6. The micro liquid control system according to the claim 2, wherein a target object forming means to form the droplet of the target objects is provided at the microchannel; and
the electrical charging part charges the target objects during the formation of the droplet of the target objects by the target object forming means.

7. The micro liquid control system according to the claim 6, wherein the target object forming means comprises a droplet forming channel which crosses the main channel of the microchannel through a cross area and flows a parent phase liquid forming a parent phase of the target objects, and the main liquid flowing in the main channel of the microchannel severs the flow of the liquid in the droplet forming channel at the cross area to form the target objects.

8. The micro liquid control system according to the claim 7, wherein, the electrical charging part comprises;
a charging electrode which induces an electrostatic filed on extremity part of the parent phase liquid when the parent phase liquid entering into the cross area from the droplet forming channel is pushed by the main liquid along the microchannel and when the extremity part of the parent phase liquid arrives just at the downstream edge of the cross area in the main channel; and
a terminal whose one end is arranged to be in contact with the parent phase liquid in the droplet forming channel and the other end is connected to the ground, thus connecting the parent phase liquid of the droplet forming channel to the ground.

9. The micro liquid control system according to the claim 8, wherein the charging electrode, provided just at the downstream side of the cross area in the main channel of the microchannel, attracts a positive or negative charge of the extremity part of the parent phase liquid which enters into the main channel from the droplet forming channel at the cross area.

10. The micro liquid control system according to claims 2, wherein the parent phase liquid is to be a cell suspension containing cells;
the target object forming means forms a droplet of the target objects containing the cells therein when the parent phase liquid is severed by the main liquid;
an information detecting part, provided at the cross area of the microchannel, which irradiates detecting light to the extremity part of the parent phase liquid entering into the main channel from the droplet forming channel in order to detect whether a specific target cells are contained in the extremity part of the parent phase liquid or not; and
the electrical charging part changes the polarity of the charging electrode depending on whether the specific target cells are contained or not in the extremity part of the parent phase liquid.

11. The micro liquid control system according to the claim 10, wherein the information detecting part irradiates the detecting light on the area of the parent phase liquid where the width of the parent phase liquid becomes narrow, when the parent phase liquid is severed by the main liquid.

12. The micro liquid control system according to the claim 1, wherein the target object forming means which forms the target objects is provided at the microchannel.

13. The micro liquid control system according to the claim 12, wherein the target object forming means comprises a droplet forming channel which crosses the main channel of the microchannel through a cross area and flows a parent phase liquid forming a parent phase of the target objects, and the main liquid flowing in the main channel of the microchannel severs the flow of the liquid in the droplet forming channel at the cross area to form the target objects.

14. A micro liquid control system comprising:
a microchannel including a main channel to flow a main liquid in which fine target objects are dispersed and a sorting channel which, situated at the downstream side of the main channel, sorts the target objects; and
a target object selecting means which selects the target objects flowing in the microchannel and supplies them to the sorting channel,
wherein the target object selecting means is provided with a magnetic field generating part which moves the target objects flowing in the main channel of the microchannel with an electromagnetic force and selects the target objects.

15. The micro liquid control system according to the claim 14, wherein the target object selecting means comprises an electrical charging part which charges the target objects flowing in the microchannel at the upstream side of the magnetic field generating part.

16. The micro liquid control system according to the claim 15, wherein a target object forming means to form the target objects is provided at the upstream side of the target object selecting means in the microchannel; and
the electrical charging part charges the target objects after the formation of a droplet of the target objects by the target object forming means.

17. The micro liquid control system according to the claim 15, wherein a target object forming means to form the droplet of the target objects is provided at the microchannel; and
the electrical charging part charges the target objects during the formation of the droplet of the target objects by the target object forming means.

18. A micro liquid control system comprising:
a microchannel including a main channel to flow a main liquid in which fine target objects are dispersed and a sorting channel which, situated at the downstream side of the main channel, sorts the target objects; and
a target object selecting means which selects the target objects flowing in the microchannel and supplies them to the sorting channel,
wherein the target object selecting means is provided with an electrode which attracts, with the application of a voltage, the target object flowing in the main channel of the microchannel when the dielectric constant of the target objects is larger than that of the main liquid.

19. The micro liquid control system according to the claim 18, wherein the target object forming means to form the target objects is provided at the upstream side of the target object selecting means in the microchannel.

20. The micro liquid control system according to the claim 18, wherein the target object forming means comprises a droplet forming channel which crosses the main channel of the microchannel through the cross area and flows a liquid forming a parent phase of the target objects, and the main liquid flowing in the main channel of the microchannel severs the flow of the liquid in the droplet forming channel at the cross area to form a plurality of droplets of the target objects.
